(19) United States
(12) Patent Application Publication
(10) Pub. No.: US 2025/0378366 A1
(43) Pub. Date: Dec. 11, 2025

(54) Follower clock holdover system

(71) Applicant: Mellanox Technologies, Ltd., Yokneam (IL)

(72) Inventors: Nir Laufer, Zoran (IL); Dror Porat, Haifa (IL); Bar Shapira, Tel Aviv (IL); Thomas Kernen, Russin (CH); Gil Shabat, Hod Hasharon (IL)

(21) Appl. No.: 18/735,293

(22) Filed: Jun. 6, 2024

(51) Int. Cl. G06N 20/00; G06F 1/12

(52) U.S. Cl. CPC G06N 20/00; G06F 1/12

(57) ABSTRACT

In one embodiment, a system includes clock circuitry to generate a local clock signal, the clock circuitry including an oscillator, clock synchronization circuitry to adjust the local clock signal based on a remote clock, and a processor to train a machine learning model to predict a frequency or a frequency adjustment for applying to the local clock signal during clock holdover.

### FIELD OF THE DISCLOSURE

The present invention relates to computer systems, and in particular, but not exclusively, to clock frequency adjustment.

### BACKGROUND

Clock synchronization among network devices is used in many network applications. One application of using a synchronized clock value is measuring one-way latency from one device to another device. If the clocks are not synchronized the resulting one-way latency measurement will be inaccurate. Synchronization is typically achieved by syntonization (in which the clock frequency of two devices is aligned) and by aligning the phase between the two devices.

A local clock running on a device (e.g., a network interface controller (NIC)) may be synchronized using any suitable method, such as using PTP, SyncE, and/or synchronized to a global navigation satellite system (GNSS).

For Ethernet, there are two complementary methods to achieve synchronization. One is Synchronous Ethernet (SyncE), which is a physical-layer protocol which achieves syntonization based on the receive/transmit symbol rate. SyncE is an International Telecommunication Union Telecommunication (ITU-T) Standardization Sector standard for computer networking (e.g., ITU-T G.8262/G.8262.1) that facilitates the transference of clock signals over the Ethernet physical layer. In particular, SyncE enables clock syntonization inside a network with respect to a master clock.

The other is Precision Time Protocol (PTP) (documented in IEEE standard 1588), which is a packet-based protocol that may be used with SyncE to align offset (e.g., in Coordinated Universal Time (UTC) format) and phase between two clocks. PTP is used to accurately synchronize clocks throughout a computer network and is considered to be the de facto standard for this purpose. PTP is an example of a two-way time synchronization protocol. A two-way time synchronization protocol uses time synchronization packets which are exchanged in both directions between a clock leader and a clock follower.

In some systems, the local clock may be adjusted based on frequency updates provided by a software application running on a processor, for example, in a host device. The software managing the clock (sometimes referred to as “servo”) disciplines the clock by measuring the clock's error against some clock synchronization leader and issues adjustment commands to correct the clock errors. The software generally simultaneously corrects for different types of errors including: (a) long-term errors (which are typically measured over time periods of days), for example, oscillator aging, (b) medium-term errors (typically measured over time periods of minutes), for example, ambient/oscillator temperature changes, (c) short-term errors (typically measured over time periods of milliseconds), for example, oscillator frequency instabilities, and jitter due to hardware limitations (e.g., clock quantization and inaccuracies).

### OVERVIEW

There is provided in accordance with an embodiment of the present disclosure, a system, including clock circuitry to generate a local clock signal, the clock circuitry including an oscillator, clock synchronization circuitry to adjust the local clock signal based on a remote clock, and a processor to train a machine learning model to predict a frequency or a frequency adjustment for applying to the local clock signal during clock holdover.

Further in accordance with an embodiment of the present disclosure the clock circuitry includes a hardware clock driven by the local clock signal.

Still further in accordance with an embodiment of the present disclosure the processor is to train the machine learning model based on data collected during at least one period in which the remote clock is available to the system for clock synchronization purposes.

Additionally in accordance with an embodiment of the present disclosure the data collected includes frequency adjustments made to the local clock signal and one or more of the following measurements of an environmental parameter, measurements indicative of a temperature of the oscillator, measurements indicative of a vibration of the oscillator, aging of the oscillator, or measurements of humidity.

Moreover, in accordance with an embodiment of the present disclosure, the system includes at least one sensor to measure the temperature of the oscillator and/or the vibration of the oscillator and/or the humidity.

Further in accordance with an embodiment of the present disclosure processor is to filter data used to train the machine learning model or to filter prediction data output by the trained machine learning model based on data derived from a technical specification of the oscillator.

Still further in accordance with an embodiment of the present disclosure processor is to execute the machine learning model to predict the frequency or the frequency adjustment for applying to the local clock signal during the clock holdover.

Additionally in accordance with an embodiment of the present disclosure the clock synchronization circuitry is to apply the predicted frequency or the predicted frequency adjustment to adjust the local clock signal.

Moreover in accordance with an embodiment of the present disclosure the machine learning model is to predict the frequency or the frequency adjustment based on any one or more of the following at least one measurement of an environmental parameter taken during the clock holdover, at least one measurement of temperature of the oscillator taken during the clock holdover, at least one measurement of vibration of the oscillator taken during the clock holdover, an age of the oscillator during the clock holdover, a measurement of humidity taken during the clock holdover, prior frequency adjustments to the local clock signal during the clock holdover, a current frequency of the local clock signal during the clock holdover, or when the clock holdover started.

Further in accordance with an embodiment of the present disclosure, the system includes at least one sensor to measure the temperature of the oscillator and/or the vibration of the oscillator and/or the humidity.

Still further in accordance with an embodiment of the present disclosure the processor or the machine learning model is to provide a confidence level associated with the prediction of the frequency or the frequency adjustment.

Additionally in accordance with an embodiment of the present disclosure the machine learning model may be trained in accordance with any one or more of the following machine learning models a time series prediction model, an ARIMA model, an autoregressive model, a moving average model, a recurrent neural network (RNN), a long short-term memory (LSTM), a gated recurrent unit (GRU), or a transformer model.

There is also provided in accordance with another embodiment of the present, disclosure a system, including a processor to execute a trained machine learning model to predict a frequency or a frequency adjustment for applying to a local clock signal during the clock holdover, and a memory to store data used by the processor.

Moreover, in accordance with an embodiment of the present disclosure, the system includes clock circuitry to generate the local clock signal, the clock circuitry including an oscillator, and clock synchronization circuitry to adjust the local clock signal based on a remote clock.

Further in accordance with an embodiment of the present disclosure the clock synchronization circuitry is to apply the predicted frequency or the predicted frequency adjustment to adjust the local clock signal.

Still further in accordance with an embodiment of the present disclosure the machine learning model is to predict the frequency or the frequency adjustment based on any one or more of the following at least one measurement of an environmental parameter taken during the clock holdover, at least one measurement of temperature of an oscillator taken during the clock holdover, at least one measurement of vibration of the oscillator taken during the clock holdover, an age of the oscillator during the clock holdover, a measurement of humidity taken during the clock holdover, prior frequency adjustments to the local clock signal during the clock holdover, a current frequency of the local clock signal during the clock holdover, or when the clock holdover started.

Additionally in accordance with an embodiment of the present disclosure, the system includes at least one sensor to measure the temperature of the oscillator and/or the vibration of the oscillator and/or the humidity.

Moreover, in accordance with an embodiment of the present disclosure the processor or the machine learning model is to provide a confidence level associated with the prediction of the frequency or the frequency adjustment.

There is also provided in accordance with still another embodiment of the present disclosure, a method, including generating a local clock signal, adjusting the local clock signal based on a remote clock, and training a machine learning model to predict a frequency or a frequency adjustment for applying to the local clock signal during clock holdover.

Further in accordance with an embodiment of the present disclosure the training includes training the machine learning model based on data collected during at least one period in which the remote clock is available to the device for clock synchronization purposes.

Still further in accordance with an embodiment of the present disclosure the data collected includes frequency adjustments made to the local clock signal and one or more of the following measurements of an environmental parameter, measurements indicative of a temperature of an oscillator, measurements indicative of a vibration of the oscillator, aging of the oscillator, or measurements of humidity.

Additionally in accordance with an embodiment of the present disclosure, the method includes measuring the temperature of the oscillator and/or the vibration of the oscillator and/or the humidity.

Moreover, in accordance with an embodiment of the present disclosure, the method includes filtering data used to train the machine learning model or filtering prediction data output by the trained machine learning model based on data derived from a technical specification of an oscillator.

Further in accordance with an embodiment of the present disclosure, the method includes executing the machine learning model to predict the frequency or the frequency adjustment for applying to the local clock signal during the clock holdover.

Still further in accordance with an embodiment of the present disclosure, the method includes predicting the frequency or the frequency adjustment based on any one or more of the following at least one measurement of an environmental parameter taken during the clock holdover, at least one measurement of temperature of an oscillator taken during the clock holdover, at least one measurement of vibration of the oscillator taken during the clock holdover, an age of the oscillator during the clock holdover, a measurement of humidity taken during the clock holdover, prior frequency adjustments to the local clock signal during the clock holdover, a current frequency of the local clock signal during the clock holdover, or when the clock holdover started.

Additionally in accordance with an embodiment of the present disclosure, the method includes measuring the temperature of the oscillator and/or the vibration of the oscillator and/or the humidity.

Moreover, in accordance with an embodiment of the present disclosure, the method includes providing a confidence level associated with the prediction of the frequency or frequency adjustment.

Further in accordance with an embodiment of the present disclosure the machine learning model may be trained in accordance with any one or more of the following machine learning models a time series prediction model, an ARIMA model, an autoregressive model, a moving average model, a recurrent neural network (RNN), a long short-term memory (LSTM), a gated recurrent unit (GRU), or a transformer model.

There is also provided in accordance with still another embodiment of the present disclosure, a method, including executing a trained machine learning model to predict a frequency or a frequency adjustment for applying to a local clock signal during the clock holdover, and applying the predicted frequency or the predicted frequency adjustment to adjust the local clock signal.

### BRIEF DESCRIPTION OF THE DRAWINGS

The present disclosure will be understood from the following detailed description, taken in conjunction with the drawings in which:

FIG. 1 is a block diagram view of a clock synchronization system constructed and operative in accordance with an embodiment of the present disclosure;

FIG. 2 is a flowchart including steps in a method to train a machine learning model to predict frequency (adjustment) for use in the system of FIG. 1; and

FIG. 3 is a flowchart including steps in a method to apply a trained machine learning model to predict frequency (adjustment) during holdover for use in the system of FIG. 1.

### DESCRIPTION OF EXAMPLE EMBODIMENTS

### Overview

The local clock running on a device (such as peripheral device (e.g., a network interface controller (NIC)), or a switch, or a device including a graphics processing unit (GPU), data processing unit (DPU), or central processing unit (CPU)), may be adjusted based on frequency updates. In some cases, the frequency updates may be provided by a software application (e.g., servo) running on a processor, for example, in a host device. The hardware and/or software managing the updates disciplines the clock by measuring the clock's error against some clock synchronization leader and issues adjustment commands to correct the clock errors.

A clock is described as being in state of “holdover” if it is no longer being disciplined according to measurements of the clock's error against some reference (e.g., a clock synchronization leader). Holdover may be a result of some failure to receive clock updates such as connectivity loss, failure of the reference, or failure of software managing the clock. The corrections applied to the clock (e.g., by the software) are persistent even if the entity controlling the clock no longer controls the clock. This means that if there is a failure, the clock will be “dead reckoning” with the last adjustment the clock received (e.g., from the software) and the clock accuracy in the state of holdover is entirely decided by the last adjustment. This is not generally a satisfactory solution as the previous correction corrects for short-term, medium-term, and long-term errors. Additionally, using the last adjustment in the long term generally leads to a large clock drift.

Using the last adjustment while there is a failure (such as a software failure) may be problematic in at least two cases in particular: (1) if a clock control loop uses frequency adjustments to compensate for time error leading to relatively high-amplitude frequency adjustments in regular operation; and (2) the clock control loop is currently responding to a transient timing error (e.g., due to network congestion or network reconfiguration).

To summarize, a clock follower may be locked onto a reference clock of a clock leader. During this time, the clock follower adjusts its clock to follow the reference clock. If the reference clock is lost or becomes otherwise unavailable or unusable, the clock follower goes into holdover and tries to estimate how the local clock should be adjusted.

Embodiments of the present disclosure address at least some of the above drawbacks of the prior art by training a machine learning model based on historical data collected during the locked-on phase (e.g., temperature measurements, vibration measurements, humidity measurements, aging data, and frequency adjustments). Once trained, the machine learning model may be used to predict frequency or frequency adjustments to the local clock during holdover, based on data acquired during holdover (e.g., temperature measurement(s), vibration measurement(s), humidity measurement(s), aging data, and previous frequency or frequency adjustment(s), and when holdover started).

The device may include sensors such as temperature, vibration, and humidity sensors to provide measurements of temperature, vibration, and humidity in the vicinity of the oscillator. Hardware counters may be used to estimate the oscillator's fractional frequency offset (FFO) during the locked-on phase.

### System Description

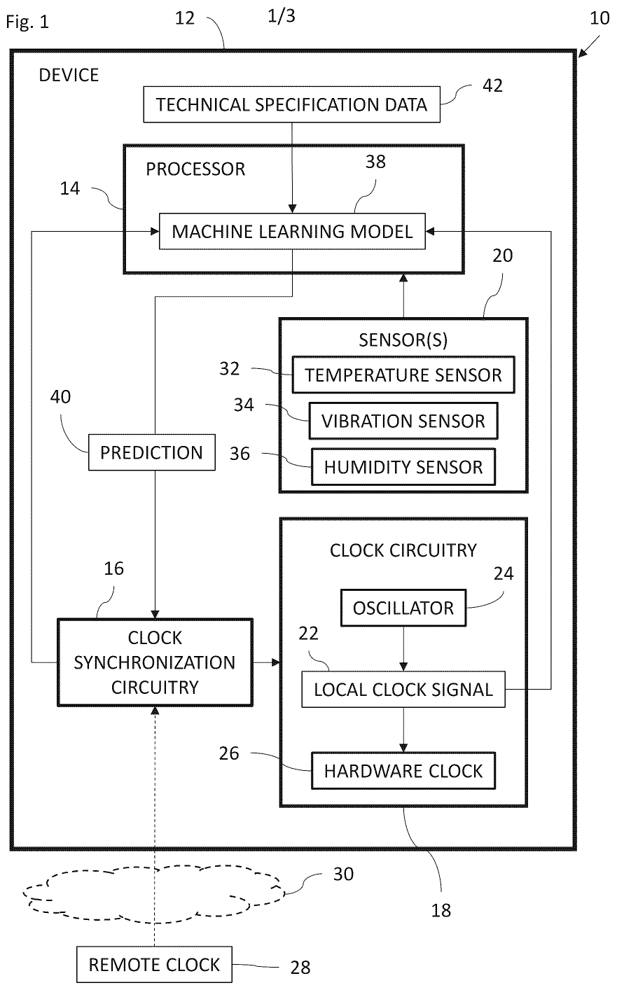

Reference is now made to FIG. 1, which is a block diagram view of a clock synchronization system 10 constructed and operative in accordance with an embodiment of the present disclosure. The clock synchronization system 10 includes a device 12 such as a network device, or a smart NIC (e.g., a device including a network interface controller (NIC), a network switch, and a data processing unit (DPU)), or a device including a graphics processing unit (GPU) and/or a central processing unit (CPU)). Device 12 may include a processor 14, a memory 15, clock synchronization circuitry 16, clock circuitry 18, and one or more sensors 20. Memory 15 is configured to store data used by processor 14.

The clock circuitry 18 is configured to generate a local clock signal 22. The clock circuitry may include an oscillator 24 to generate the local clock signal 22. The clock circuitry 18 may include a hardware clock 26 driven by the local clock signal 22. The hardware clock 26 may be configured to maintain a time-of-day value, or a counter value from which a time-of-day value may be computed based on one or more clock parameters. The clock synchronization circuitry 16 is configured to adjust the local clock signal 22 based on a remote clock 28. In some embodiments, the clock synchronization circuitry 16 is configured to recover the remote clock 28 from a clock signal received from a remote device (e.g., via a network 30 or via a clock connection or highspeed connection from another device), or from a GNSS signal. The clock synchronization circuitry 16 is configured to compare the remote clock to the local clock signal 22 and/or time output by the hardware clock 26. The clock synchronization circuitry 16 may then apply one or more suitable clock adjustments to the local clock signal 22. In some embodiments, the clock synchronization circuitry 16 is configured to recover the remote clock 28 using a packet-based clock synchronization method, such as PTP, in which PTP packets are timestamped by the clock synchronization circuitry 16 based on the time provided by the hardware clock 26 and passed to clock synchronization software running on a processor disposed in the device 12 or in a host device connected to the device 12. The clock synchronization software may then issue commands to the clock synchronization circuitry 16 to adjust the local clock signal 22 and/or the hardware clock 26.

The sensor(s) 20 may include any one or more of the following: a temperature sensor 32, a vibration sensor 34, and/or a humidity sensor 36. The sensor(s) 20 may be disposed in any suitable location in device 12. The sensor(s) 20 may be disposed near to and/or adjacent to and/or inside the oscillator 24. The temperature sensor 32 is configured to measure temperature of the oscillator 24, or in the vicinity of the oscillator 24. The vibration sensor 34 is configured to measure vibration of the oscillator 24, or in the vicinity of the oscillator 24. The oscillator 24 may be configured to measure the vibration of the oscillator 24 according to the fan speed of a fan (not shown) operating in device 12. The humidity sensor 36 is configured to measure humidity around the oscillator 24. The measurements provided by sensor(s) 20 provide training input to a machine learning model 38 described in more detail below. The measurements provided by the sensor(s) 20 may also be used by the machine learning model 38 to predict frequency or frequency adjustments to be made to the local clock signal 22 during holdover, described in more detail below.

The processor 14 is configured to train machine learning model 38 to predict a frequency or a frequency adjustment for applying to the local clock signal during clock holdover, based on data collected prior to the clock holdover, e.g., based on data collected during at least one period in which the remote clock 28 is available to the device 12 for clock synchronization purposes. The processor 14 is also configured to execute the machine learning model 38 to provide a prediction 40 (i.e., to perform inference) of frequency or frequency adjustment to the clock synchronization circuitry 16 to adjust the local clock signal 22 based on data provided by the sensor(s) 20 and previous frequency setting/adjustments, as described in more detail below. The machine learning model 38 may be executed by any suitable processor (e.g., CPU and/or GPU) disposed in the device 12 or in a remote device, such as in a cloud-based server, connected via a network. Technical specification data 42 about the oscillator 24 (e.g., providing tolerance of the oscillator 24 based on temperature, vibrations, humidity, and aging) may be used to filter training data and/or the prediction 40 as described in more detail below.

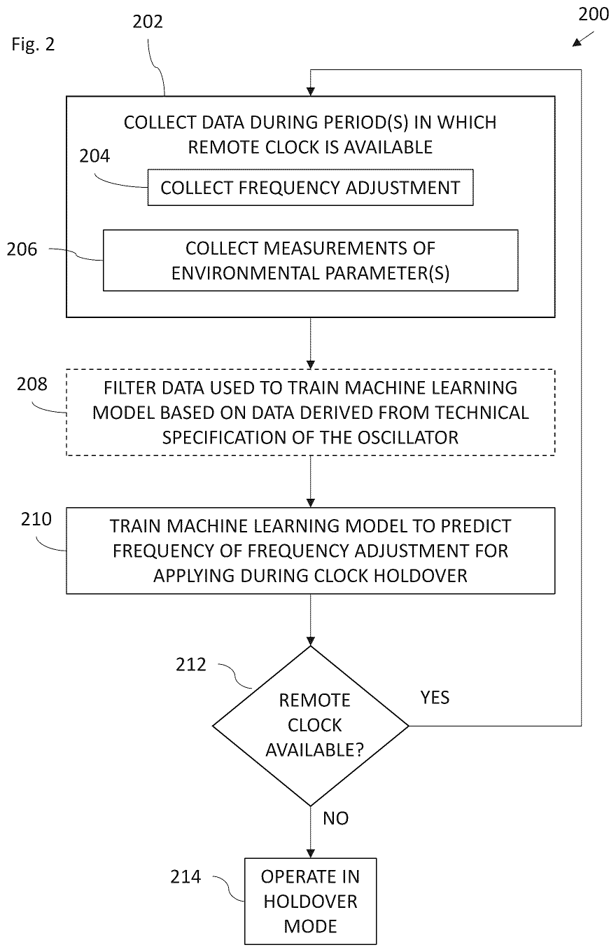

Reference is now made to FIG. 2, which is a flowchart 200 including steps in a method to train machine learning model 38 to predict frequency or frequency adjustment for use in the system 10 of FIG. 1. The processor 14 is configured to collect data during periods in which the remote clock 28 is available and usable (block 202) by device 12. The processor 14 may be configured to collect frequency adjustments applied by the clock synchronization circuitry 16 to the local clock signal 22 (block 204) and collect measurements of environmental parameters of the oscillator 24 (block 206) measured during periods in which the remote clock 28 is available and usable (i.e., not during clock holdover). The data collected may include frequency adjustments made to the local clock signal 22 and one or more of the following: measurements of an environmental parameter; measurements indicative of a temperature of the oscillator 24; measurements indicative of vibration of the oscillator 24; aging of the oscillator 24; or measurements of humidity around the oscillator 24. The measurements of the environmental parameter(s) may be provided by the sensor(s) 20. The collected data is typically grouped as sets of training data, for example, each training data set may include a most recent frequency adjustment (and optionally a prior frequency adjustment) and at least one corresponding measurement of an environmental parameter (e.g., temperature, vibration, age, and/or humidity) of the oscillator 24 at or around the time of the most recent frequency adjustment. The collected training data may include, for example, a frequency adjustment and corresponding measurement(s) of environmental parameter(s) at or around time t1, a frequency adjustment and corresponding measurement(s) of environmental parameter(s) at or around time t2, and so on. In some embodiments, the training data set may include a change and/or rate of change of measurements of the environmental parameter(s) such as temperature, humidity, and/or vibration.

The processor 14 may be configured to filter data (e.g., the collected training data) used to train the machine learning model 38 based on data derived from technical specification data 42 of the oscillator 24 (block 208). In some embodiments, the processor 14 may remove some of the data from the collected training data based on one or more of the data sets including data which deviates from the technical specification data 42 by a given limit. For example, if the measured temperature is 30 degrees C. and the measured frequency difference is 7 parts per billion (ppb) and the expected frequency difference is 5 ppb at that temperature, then the data may be removed from the training data.

The processor 14 is configured to train the machine learning model 38 to predict a frequency or a frequency adjustment for applying to the local clock signal 22 during clock holdover based on the collected (and optionally filtered) training data (block 210). For example, a neural network may be trained based on providing the measurements of environmental parameters as input to the neural network, providing the frequency adjustments made to the local clock signal 22 or the frequency of the local clock signal 22 as target output of the neural network, and adjusting the weights of the neural network according to a suitable loss function. The machine learning model 38 may be trained in accordance with any suitable machine learning method. The machine learning model 38 may be trained in accordance with any one or more of the following machine learning models: a time series prediction model; an ARIMA model; an autoregressive model; a moving average model; a recurrent neural network (RNN); a long short-term memory (LSTM), a gated recurrent unit (GRU); or a transformer model. In some embodiments, reinforcement learning may be used to learn how well the predictions made in the holdover period compare with values derived from the remote clock once the device 12 is reconnected to the remote clock 28.

Processor 14 may be configured to retrain or improve the training of the machine learning model 38 based on additional training data collected over time. In a decision block 212, the processor 14 may be configured to determine if the remote clock 28 is still available and usable by the clock synchronization circuitry 16 or a connected host device, and then repeat the steps of blocks 202-210. If the remote clock 28 is not available or usable, the processor 14 is configured to operate in holdover mode (block 214) and execute the machine learning model 38 to predict frequencies or frequency adjustments to be applied to the local clock signal 22 based on collected measurements of environmental parameter(s) and optionally other data, described in more detail below.

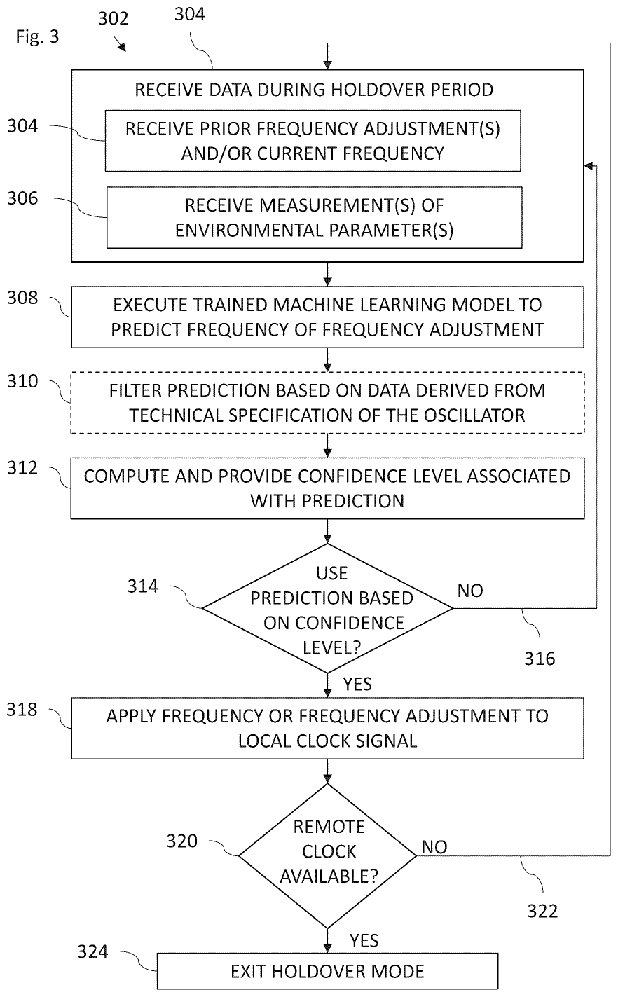

Reference is now made to FIG. 3, which is a flowchart 300 including steps in a method to apply machine learning model 38 to predict a frequency or frequency adjustment during holdover for use in the system 10 of FIG. 1. The processor 14 is configured to receive data during the holder period (block 302) including receiving prior frequency adjustment(s) and/or the current frequency of the local clock signal 22 (block 304) and current or recent measurement(s) of environmental parameter(s), e.g., from the sensor(s) 20 (block 306) taken during the holdover period.

The processor 14 is to execute the machine learning model 38 to predict the frequency or the frequency adjustment for applying to the local clock signal 22 during the clock holdover based on the data received in the step of block 302 as input into the machine learning model 38 (block 308). The machine learning model 38 is configured to predict the frequency or the frequency adjustment based on any one or more of the following: at least one measurement of an environmental parameter or parameters taken during the clock holdover; at least one measurement of temperature of the oscillator taken during the clock holdover; at least one measurement of vibration of the oscillator taken during the clock holdover; an age of the oscillator during the clock holdover; a measurement of humidity taken during the clock holdover; prior frequency adjustment(s) to the local clock signal 22 during the clock holdover; a current frequency of the local clock signal 22 during the clock holdover; and/or when the clock holdover started. In some embodiments, the data input into the machine learning model 38 may include a change and/or rate of change of measurements of the environmental parameter(s) such as temperature, humidity, and/or vibration.

In some embodiments, the processor 14 may be configured to filter the prediction data output by the trained machine learning model 38 based on data derived from technical specification data 42 of the oscillator 24 (block 310). For example, if the predicted frequency adjustment is outside of the expected behavior of the oscillator 24 by a given amount or fraction at the measured environment parameters or age etc., then the predicted frequency adjustment may not be used by the device 12 to adjust the local clock signal 22.

The processor 14 or the machine learning model 38 may be configured to provide a confidence level associated with the prediction of the frequency or frequency adjustment (block 312). The confidence level may be generated as part of the machine learning model 38 or by taking a number of predictions and computing a standard error or the mean of the predictions. The confidence level may be provided to software or a processor (e.g., the clock synchronization circuitry 16 or the processor 14) to determine if the predicted frequency or frequency adjustment is worth using to adjust the local clock signal 22. At a decision block 314, the processor 14 or the clock synchronization circuitry 16 may be configured to determine whether or not to use the prediction based on the confidence level of the prediction. If it is determined not to use the prediction, the steps of blocks 302 to 312 are repeated (arrow 316). If it is determined to use the prediction, the clock synchronization circuitry 16 is configured to apply the predicted frequency or frequency adjustment to adjust the local clock signal 22 (block 318). At a decision block 320, processor 14 is configured to determine if the remote clock is currently available for clock synchronization purposes. If the remote clock 28 is still not available (i.e., clock holdover is still be applied), the steps of blocks 302-318 are repeated (arrow 322) as applicable. If remote clock 28 is now available, holdover mode is exited (block 324), and the steps of flowchart 200 may be repeated to further train the machine learning model 38.

In practice, some or all of the functions of the processor 14 may be combined in a single physical component or, alternatively, implemented using multiple physical components. These physical components may comprise hard-wired or programmable devices, or a combination of the two. In some embodiments, at least some of the functions of the processor 14 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
clock circuitry to generate a local clock signal, the clock circuitry including an oscillator;
clock synchronization circuitry to adjust the local clock signal based on a remote clock; and
a processor to train a machine learning model to predict a frequency or a frequency adjustment for applying to the local clock signal during clock holdover.

2. The system according to claim 1, wherein the clock circuitry includes a hardware clock driven by the local clock signal.

3. The system according to claim 1, wherein the processor is to train the machine learning model based on data collected during at least one period in which the remote clock is available to the system for clock synchronization purposes.

4. The system according to claim 3, wherein the data collected includes frequency adjustments made to the local clock signal and one or more of the following: measurements of an environmental parameter; measurements indicative of a temperature of the oscillator; measurements indicative of a vibration of the oscillator; aging of the oscillator; or measurements of humidity.

5. The system according to claim 4, further comprising at least one sensor to measure the temperature of the oscillator and/or the vibration of the oscillator and/or the humidity.

6. The system according to claim 3, wherein processor is to filter data used to train the machine learning model or to filter prediction data output by the trained machine learning model based on data derived from a technical specification of the oscillator.

7. The system according to claim 1, wherein processor is to execute the machine learning model to predict the frequency or the frequency adjustment for applying to the local clock signal during the clock holdover.

8. The system according to claim 7, wherein the clock synchronization circuitry is to apply the predicted frequency or the predicted frequency adjustment to adjust the local clock signal.

9. The system according to claim 7, wherein the machine learning model is to predict the frequency or the frequency adjustment based on any one or more of the following: at least one measurement of an environmental parameter taken during the clock holdover; at least one measurement of temperature of the oscillator taken during the clock holdover; at least one measurement of vibration of the oscillator taken during the clock holdover; an age of the oscillator during the clock holdover; a measurement of humidity taken during the clock holdover; prior frequency adjustments to the local clock signal during the clock holdover; a current frequency of the local clock signal during the clock holdover; or when the clock holdover started.

10. The system according to claim 9, further comprising at least one sensor to measure the temperature of the oscillator and/or the vibration of the oscillator and/or the humidity.

11. The system according to claim 7, wherein the processor or the machine learning model is to provide a confidence level associated with the prediction of the frequency or the frequency adjustment.

12. The system according to claim 1, wherein the machine learning model may be trained in accordance with any one or more of the following machine learning models: a time series prediction model; an ARIMA model; an autoregressive model; a moving average model; a recurrent neural network (RNN); a long short-term memory (LSTM), a gated recurrent unit (GRU); or a transformer model.

13. A system, comprising:
a processor to execute a trained machine learning model to predict a frequency or a frequency adjustment for applying to a local clock signal during the clock holdover; and
a memory to store data used by the processor.

14. The system according to claim 13, further comprising:
clock circuitry to generate the local clock signal, the clock circuitry including an oscillator; and
clock synchronization circuitry to adjust the local clock signal based on a remote clock.

15. The system according to claim 14, wherein the clock synchronization circuitry is to apply the predicted frequency or the predicted frequency adjustment to adjust the local clock signal.

16. The system according to claim 13, wherein the machine learning model is to predict the frequency or the frequency adjustment based on any one or more of the following: at least one measurement of an environmental parameter taken during the clock holdover; at least one measurement of temperature of an oscillator taken during the clock holdover; at least one measurement of vibration of the oscillator taken during the clock holdover; an age of the oscillator during the clock holdover; a measurement of humidity taken during the clock holdover; prior frequency adjustments to the local clock signal during the clock holdover; a current frequency of the local clock signal during the clock holdover; or when the clock holdover started.

17. The system according to claim 16, further comprising at least one sensor to measure the temperature of the oscillator and/or the vibration of the oscillator and/or the humidity.

18. The system according to claim 13, wherein the processor or the machine learning model is to provide a confidence level associated with the prediction of the frequency or the frequency adjustment.

19. A method, comprising:
generating a local clock signal;
adjusting the local clock signal based on a remote clock; and
training a machine learning model to predict a frequency or a frequency adjustment for applying to the local clock signal during clock holdover.

20. A method, comprising:
executing a trained machine learning model to predict a frequency or a frequency adjustment for applying to a local clock signal during the clock holdover; and
applying the predicted frequency or the predicted frequency adjustment to adjust the local clock signal.
